(19) United States
(12) Patent Application Publication
(10) Pub. No.: US 2016/0245496 A1
(43) Pub. Date: Aug. 25, 2016

(54) Light with a film for altering the radiation characteristics

(71) Applicants: Juergen RAPP, Eschbronn (DE); Clemens HUMMEL, Villingen-Schwenningen (DE)

(72) Inventors: Juergen RAPP, Eschbronn (DE); Clemens HUMMEL, Villingen-Schwenningen (DE)

(73) Assignee: HERBERT WALDMANN GmbH & Co. KG, Villingen-Schwenningen (DE)

(21) Appl. No.: 14/241,017

(22) PCT Filed: Sep. 6, 2012
(86) PCT No.: PCT/DE2012/100270

§ 371 Date: May 11, 2016

(30) Foreign Application Priority Data
Sep. 9, 2011 (DE) 10 2011 082 424.3

(51) Int. Cl. F21V 29/507; F21V 3/00; F21V 5/00; F21V 17/10; F21V 29/74

(52) U.S. Cl. CPC F21V 29/507; F21V 17/10; F21V 17/101; F21V 29/74; F21V 5/002; F21V 3/00; F21Y 2101/02; F21W 2131/402

(57) ABSTRACT

Light with housing, a plurality of illuminants arranged in the housing, a covering disc that closes the housing in the direction of radiation and a film for altering the radiation characteristics of the illuminants, which is arranged in front of the illuminants in the direction of radiation, wherein the film is arranged between the covering disc and a supporting disc, wherein the film is in direct contact with the two discs.

### CROSS REFERENCE TO RELATED APPLICATIONS

This patent application claims priority to International Patent Application PCT/DE2012/100270, filed on Sep. 6, 2012 and thereby to German Patent Application 10 2011 082 424.3, filed on Sep. 9, 2011.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The invention relates to a light with a film for altering the radiation characteristics

2. Background of the Invention

The current state of knowledge is as follows.

Radiation-reducing lights generally comprise a housing with a plurality of illuminants arranged in it. In the front, the housing is closed with a covering disc in the direction of radiation. Furthermore, a film is arranged in front of the illuminants in the direction of radiation, said film altering the radiation characteristics of the illuminants, for example homogenizing the emitted light or guiding it into a certain direction.

A film for homogenizing the emitted light may be required for example in the event that the illuminants arranged in the housing generate a plurality of light cones, which would subsequently cast a plurality of shadows if the light is used for instance as a work or machine light. To prevent this from happening, a so-called diffuser film is required, which diffuses the individual light-emitting cones by optical refraction and hence prevents the casting of individual shadows. Furthermore, said type of film can bring about the shaping of the light-emitting cones of the individual illuminants, for example by deflecting them to a certain angle of radiation.

The problem associated with high-energy illuminants is that the materials used for the light are expanding at different degrees due to their different coefficients of thermal expansion, thus inducing thermal stresses. Said thermal stresses may result in corrugation and blistering of the film, especially if the film is affixed on the covering disc or clamped into the housing, such that the luminous properties of the film are lost due to the high coefficient of thermal expansion a of the film, which ranges between 70 and 80×10⁻⁶ K⁻¹. In comparison, the coefficient of thermal expansion of a housing made of aluminum is close to 23×10⁻⁶ K⁻¹ and between 3 and 4.5×10⁻⁶ K⁻¹ with the used discs. Because of these major differences, in particular a strong expansion of the film can result in considerable structural warpage, i.e., blistering or corrugation.

Moreover, lights have been disclosed in which light spots with a high luminance, produced for example with LED illuminants, are slightly scattered or homogenized by the [satin finish] of the covering disc, albeit without preventing the casting of multiple shadows. Guiding the light through lenses arranged in front of the illuminants does not resolve this problem either.

The object of the present invention is to resolve the problems mentioned above.

### BRIEF SUMMARY OF THE INVENTION

In a preferred embodiment, a light (1) with a housing (10), a plurality of illuminants (3) arranged in the housing (10), a covering disc (5) that closes the housing (10) in the direction of radiation (A) and a film (6) for altering the radiation characteristics of the illuminants (3), which is arranged in front of the illuminants (3) in the direction of radiation (A), characterized in that the film (6) is arranged between the covering disc (5) and a supporting disc (7), wherein the film (6) is in direct contact with the two discs (5, 7).

The light (1) as described herein, wherein the film (6) is mounted non-adhesively.

The light (1) as described herein, wherein at least one of the discs (5, 7) is mounted resiliently.

The light (1) as described herein, wherein the supporting disc (7) is mounted resiliently.

The light (1) as described herein, wherein the covering disc (5) is mounted resiliently.

The light (1) as described herein, wherein the supporting disc (7) is arranged on the side of the film (6) facing the illuminants (3).

The light (1) as described herein, wherein the supporting disc (7) sits on a support bearing.

The light (1) as described herein, further comprising wherein at least one cured adhesive bead is provided as support bearing.

The light (1) as described herein, further comprising wherein two adhesive beads are provided, which are arranged on opposite side walls of the supporting disc (7) or the housing (10).

The light (1) as described herein, wherein the covering disc (5) is mounted under compressive load in the direction of the supporting disc (7) in the housing (10).

The light (1) as described herein, wherein the covering disc (5) has a circumferential adhesive bond with the housing (10).

The light (1) as described herein, wherein the film (6) is kept in the center by way of a screen.

The light (1) as described herein, wherein a screen is arranged on the covering disc (5), in particular printed onto the covering disc (5).

The light (1) as described herein, wherein the screen runs around the entire circumference.

### BRIEF DESCRIPTION OF THE DRAWINGS

FIG. 1 is a line drawing evidencing a cross-section through a light according to the invention.

FIG. 2 is a line drawing evidencing a perspective representation of the light in FIG. 1.

### DETAILED DESCRIPTION OF THE INVENTION

A light according to the invention comprises a housing with a plurality of illuminants arranged in it. The housing is closed with a covering disc in the direction of radiation and additionally comprises a film for altering the radiation characteristics of the illuminants, said film being arranged in front of the illuminants in the direction of radiation. According to the invention, the light is characterized in that the film is arranged between the covering disc and a supporting disc, wherein the film is in direct contact with the two discs.

Because the film for altering the radiation characteristics of the illuminants is arranged between the covering disc and the supporting disc and is in direct contact with the two discs, a floating mount of the film between said discs is achieved, such that the film is able to perform compensating movements in all directions, but in particular in lengthwise and transverse direction of the film in response to heat-induced expansion, thus preventing blistering or corrugation. An additional advantage of the floating mount of the film is that it can be mounted between the discs without any adhesives. As a result, the film can expand or contract independent of the discs and is therefore mounted stress-free—even if the coefficients of thermal expansion of the used materials vary considerably.

In an advantageous upgrade of the invention, at least one of the discs is mounted resiliently.

The resilient mount of at least one of the discs achieves that a change in the thickness of the film can also be compensated. Furthermore, the resilient mount of at least one of the discs achieves that the film can be mounted pre-stressed in the direction of radiation, i.e., in the direction of its thickness, such that blistering or corrugation can additionally be prevented in this fashion.

A particularly simple embodiment can be achieved if the supporting disc is mounted resiliently.

The resilient mount of the supporting disc has the advantage that the covering disc, which is generally arranged behind the supporting disc in the direction of radiation and covers the housing toward the outside, can rigidly be connected with the housing and in particular the effort required to create the impermeability towards the surroundings is lower.

However, if desired, the covering disc can also be mounted resiliently; for instance, it can be interlocked with the housing.

As mentioned earlier, it is advantageous if the supporting disc is arranged on the side facing the illuminants.

The supporting disc can be mounted for example with a support bearing. The advantage of a support bearing is that an expansion of the supporting disc in lengthwise and transversal direction is not impeded by its mount in this fashion, such that the supporting disc can essentially be arranged stress-free within the housing.

A simple embodiment of said type of support bearing can be achieved with a cured adhesive bead. Said type of cured adhesive bead can be arranged for example on opposite side walls of the supporting disc or in corresponding locations on the housing. If said adhesive bead is applied and cured before the supporting disc is inserted into the housing, it features a certain degree of flexibility after being cured and the supporting disc can be mounted resiliently, while at the same time allowing an expansion of the supporting disc in lengthwise and transversal direction.

Alternatively to cured adhesive beads, other support bearings with a flexible design can also be used. One conceivable alternative would be an 0-ring arranged around the entire circumference.

A particularly effective prevention of blistering or corrugation is achieved if the covering disc is mounted in the housing under compressive load in the direction of the supporting disc. The film can be kept flat between the discs by a certain contact pressure exerted by the covering disc in the direction of the supporting disc and absorbed by the resilient support bearing.

A particularly simple mount of the covering disc can be achieved by way of adhesion provided all around the housing. Furthermore, the housing can be sealed toward the surroundings with said type of circumferential adhesion.

In addition, it is advantageous if the film is kept in the center with a screen. For this purpose, the screen can preferably have a circumferential design, where it should be made sure that the expansion of the film in lengthwise and transversal direction is still possible.

Alternatively, the screen can only be printed onto the covering disc, such that the film can expand across the entire spread of the disc.

### DETAILED DESCRIPTION OF THE FIGURES

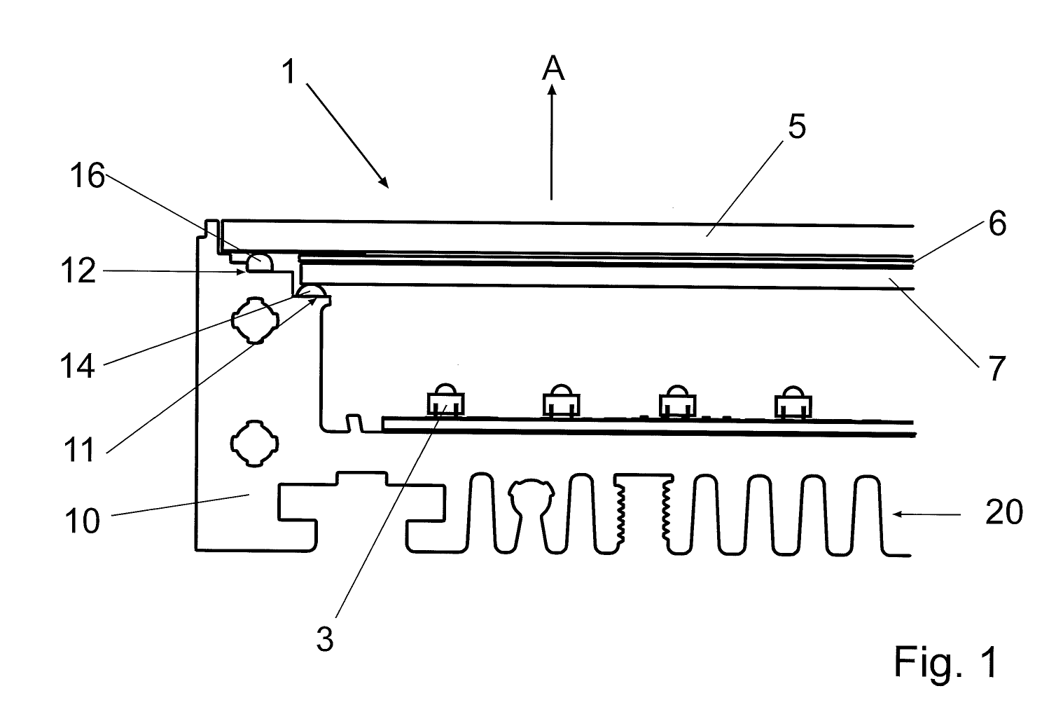

FIG. 1 shows a cross-section through a light 1 according to the invention, which is designed based on the principle of a light box. The light 1 comprises a housing 10 with a base plate and a circumferential side wall, with a plurality of illuminants 3 arranged in it. In the present example, the illuminants 3 are designed as light-emitting diodes (LEDs) and distributed uniformly on the base plate of the housing 10. To allow for the removal of lost heat created by the light-emitting diodes, the housing 10 can advantageously be made of aluminum and have a plurality of cooling ribs 20 arranged on the outside of the base plate. In the direction of radiation A, a supporting disc 7, a film 6 altering the radiation characteristics of the illuminants 3 and a covering disc 5 are arranged in the housing 10 in the fashion of a sandwich structure.

The supporting disc 7 is mounted on an elastic bearing arranged on a first step 11 that runs around the entire circumference. In the present exemplary embodiment, the elastic bearing 14 is created by a cured adhesive bead that was applied prior to the mounting of the supporting disc 7. In the present exemplary embodiment, the adhesive bead is only applied onto the first step 11 at the two side walls of the housing 10.

This allows the supporting disc 7 to expand both in lengthwise and transversal direction in response to thermal exposure and it is hence mounted floating in the housing. Another relevant feature of said floating mount is that the supporting disc 7 has an adequate distance around the entire circumference from the side wall of the housing 10, which continues in a second step 12.

A film 6 altering the radiation characteristics of the illuminants 3 is arranged in the center of the supporting disc 7. In the present exemplary embodiment, the screen is printed onto the covering disc 5, such that adequate clearance is provided for the film 6 and the screen to allow thermal expansions in lengthwise and transversal direction. The boundary area of the film 6 is therefore covered from the outside of the light and hence invisible.

The film 6 can in particular be designed as light-guiding film 6 that homogenizes the radiation characteristics.

The covering disc 5 is mounted in the housing 10 on the second step 12 by means of circumferential adhesion 16 and pushed into the housing 10 during the mounting in the housing 10 against the spring-loaded effect applied to the elastic mount 14. As a result, the film 6 is mounted under compressive load between the supporting disc 7 and the covering disc 5 such that heat-induced blistering or corrugation of the film 6 can effectively be prevented.

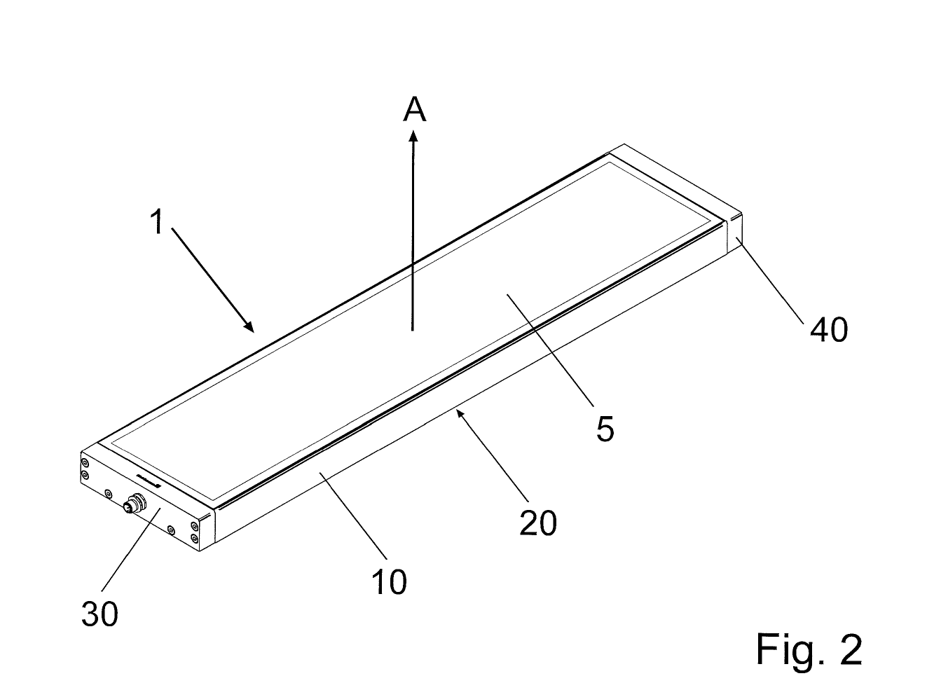

FIG. 2 shows a perspective representation of the light 1 according to the invention as it is illustrated in the cross-section in FIG. 1.

The trough-shaped housing 10 of the light 1, which is closed by the covering disc 5 in the direction of radiation, is particularly well visible in FIG. 2. On one end, the long stretched-out housing 10 is closed with a side part 30 having a connector plug, and on the other end with a side part 40 designed without a connector plug in the present exemplary embodiment. The two side parts 30, 40 are screwed down with the housing 10 in lengthwise direction of the light 1.

Furthermore, the screen printed onto the covering disc 5 is clearly visible in FIG. 2, which covers both the circumferential adhesion 16 applied to the boundary area of the covering disc 5 as well as the boundary area of the film 6, such that they are invisible from the outside.

The cooling ribs 20 at the underside of the housing 10 illustrated in FIG. 1 are not shown in FIG. 2. They are formed behind a rim of the housing 10 that runs around the entire circumference, such that a closed side wall of the housing 10 is visible toward the outside.

### LIST OF REFERENCE NUMBERS

1 Light
3 Illuminant(s)
5 Covering disc
6 Film
7 Supporting disc
10 Housing
11 First step
12 Second step
14 Elastic bearing
16 Circumferential adhesion
20 Cooling ribs
A Direction of radiation

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

We claim:

1. A light comprising a housing, a plurality of illuminants arranged in the housing, a covering disc that closes the housing in the direction of radiation and a film for altering the radiation characteristics of the illuminants, which is arranged in front of the illuminants in the direction of radiation, wherein the film is arranged between the covering disc and a supporting disc, and the film is in direct contact with the two discs.

2. The light of claim 1, mounted non-adhesively.

3. The light of claim 1, wherein at least one of the discs is mounted resiliently.

4. The light of claim 3, wherein the supporting disc is mounted resiliently.

5. The light of claim 3, wherein the covering disc is mounted resiliently.

6. The light of claim 1, wherein the supporting disc is arranged on the side of the film facing the illuminants.

7. The light of claim 1, wherein the supporting disc sits on a support bearing.

8. The light of claim 7, further comprising wherein at least one cured adhesive bead is provided as support bearing.

9. The light of claim 8, further comprising wherein two adhesive beads are provided, which are arranged on opposite side walls of the supporting disc or the housing.

10. The light of claim 1, wherein the covering disc is mounted under compressive load in the direction of the supporting disc in the housing.

11. The light of claim 1, wherein the covering disc has a circumferential adhesive bond with the housing.

12. The light of claim 1, wherein the film is kept in the center by way of a screen.

13. The light of claim 1, further comprising wherein a screen is arranged on the covering disc, in particular printed onto the covering disc.

14. The light of claim 12, wherein the screen runs around the entire circumference.
